(19) United States
(12) Patent Application Publication
(10) Pub. No.: US 2013/0054939 A1
(43) Pub. Date: Feb. 28, 2013

(54) INTEGRATED CIRCUIT HAVING A HARD CORE AND A SOFT CORE

(71) Applicant: Andrew C. FELCH, Palo Alto, CA (US)

(72) Inventor: Andrew C. FELCH, Palo Alto, CA (US)

(73) Assignee: COGNITIVE ELECTRONICS, INC., Lebanon, NH (US)

(21) Appl. No.: 13/594,181

(22) Filed: Aug. 24, 2012

Related U.S. Application Data
(60) Provisional application No. 61/528,079, filed on Aug. 26, 2011.

(51) Int. Cl. G06F 15/76

(52) U.S. Cl. 712/42; 712/E09.002

(57) ABSTRACT

An integrated circuit (IC) is disclosed. The integrated circuit includes a non-reconfigurable multi-threaded processor core that implements a pipeline having n ordered stages, wherein n is an integer greater than 1. The multi-threaded processor core implements a default instruction set. The integrated circuit also includes reconfigurable hardware that implements n discrete pipeline stages of a reconfigurable execution unit. The n discrete pipeline stages of the reconfigurable execution unit are pipeline stages of the pipeline that is implemented by the multi-threaded processor core.

### CROSS-REFERENCE TO RELATED APPLICATIONS

This application claims priority to U.S. Provisional Patent Application No. 61/528,079 filed Aug. 26, 2011, which is incorporated herein by reference.

### BACKGROUND OF THE INVENTION

Computer processor cores are typically implemented as a hard core. This is especially the case when the computer processor core is designed for power efficiency because the circuits that are fabricated using hard core fabrication techniques are much more power efficient than the reconfigurable circuits of soft cores. However, it is also possible to implement a processor core as a soft core using reconfigurable circuits, such as those provided in Field Programmable Gate Arrays (FPGAs). A soft core allows users to specify custom instructions to be integrated into the processor core. Often a custom instruction is able to perform the duties of many instructions in a single instruction.

If a processor is designed without knowing if the custom instructions will be necessary, and a reconfigurable execution unit is not available, a decision must be made whether to implement the instructions when they may not be needed, thereby increasing the cost of the processor without added benefit. Alternatively, if the custom instructions are left out of the default instruction set and they are later needed, the design results in poorer performance on those programs that need them but cannot use them.

Accordingly, it is desirable to create a hybrid processor core that combines the superior power efficiency of hard cores with the customizability provided by soft cores. It is further desirable to allow the choice of which custom instructions to include in the processor to be made after the chip has been fabricated, thereby decreasing the chances that the above negative scenarios occur.

It is further desirable to compensate for the relatively low performance of the reconfigurable circuits of a soft core by implementing multiple virtual processors per core, thereby providing latency tolerance such that instructions with multi-cycle latency can be implemented in the reconfigurable core without negative performance impact.

### BRIEF DESCRIPTION OF THE INVENTION

In one embodiment, an integrated circuit (IC) is disclosed. The integrated circuit includes a non-reconfigurable multi-threaded processor core that implements a pipeline having n ordered stages, wherein n is an integer greater than 1. The multi-threaded processor core implements a default instruction set. The integrated circuit also includes reconfigurable hardware that implements n discrete pipeline stages of a reconfigurable execution unit. The n discrete pipeline stages of the reconfigurable execution unit are pipeline stages of the pipeline that is implemented by the multi-threaded processor core.

In another embodiment, an integrated circuit is disclosed. The integrated circuit includes a non-reconfigurable multi-threaded processor core that implements a pipeline having n ordered stages. The multi-threaded processor core implements a default instruction set. The integrated circuit also includes reconfigurable hardware configurable for executing one or more instructions that are not included in the default instruction set.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an overview of a parallel computing architecture;

FIG. 2 is an illustration of a program counter selector for use with the parallel computing architecture of FIG. 1;

FIG. 3 is a block diagram showing an example state of the architecture;

FIG. 4 is a block diagram illustrating cycles of operation during which eight Virtual Processors execute the same program but starting at different points of execution;

FIG. 5 is a block diagram of a multi-core system-on-chip;

FIG. 6 is a flow chart illustrating operation of a virtual processor using a reconfigurable execution unit in accordance with one preferred embodiment of this invention;

FIG. 7 is a block diagram illustrating a reconfigurable core comprising many reconfigurable logic cells interconnected with many reconfigurable routers in accordance with one preferred embodiment of this invention;

FIG. 8 is a schematic block diagram illustrating the processor architecture of FIG. 1 in accordance with one preferred embodiment of this invention;

FIG. 9 is a block diagram of the reconfigurable core showing the storage of private data in the reconfigurable core in accordance with one preferred embodiment of this invention;

FIG. 10 illustrates an exemplary program that may be executed on the hardware of FIG. 8 in accordance with one preferred embodiment of this invention;

FIG. 11 illustrates a portion of a default instruction set for executing the program of FIG. 10 on the processing architecture shown in FIG. 8 in accordance with one preferred embodiment of this invention;

FIG. 12 illustrates an implementation of the program of FIG. 10 with the default instruction set of FIG. 11 in accordance with one preferred embodiment of this invention;

FIG. 13 illustrates an exemplary list of custom instructions that may be loaded into the reconfigurable execution unit of FIG. 8 in accordance with one preferred embodiment of this invention;

FIG. 14 illustrates the process by which a user can select custom instructions, write a program using the instructions, compile the program and run the program in accordance with one preferred embodiment of this invention;

FIG. 15 illustrates the program of FIG. 12 modified to use the custom instruction “lzeros” in accordance with one preferred embodiment of this invention;

FIG. 16 is a schematic block diagram of a parallel computing architecture in which instructions are fetched in bundles of two, called long-instruction-words in accordance with one preferred embodiment of this invention;

FIG. 17 is a schematic block diagram of the parallel computing architecture of FIG. 16 where the reconfigurable execution units 730 are implemented as a single execution unit 17010 in accordance with one preferred embodiment of this invention; and

FIG. 18 is a block diagram of a system having a hard core implementing a pipeline and a soft core implementing an execution unit in accordance with one preferred embodiment of this invention.

### DETAILED DESCRIPTION OF THE INVENTION

### Definitions

The following definitions are provided to promote understanding of the invention:

Default instruction set—the instruction set that is supported by a processor, regardless of customization. For example, given a processor core that can implement certain instructions in a custom manner through reconfiguration of reconfigurable circuits, the default instruction set comprises the instructions that are supported regardless of the configuration (or lack of configuration) of the reconfigurable circuits.

Hard Core—The term core is derived from “IP core” or intellectual property core, which simply means a circuit that carries out logical operations. A hard core is not reconfigurable, meaning that after the initial manufacturing and possible initial configuration, hard core circuits (or just “hard cores”) cannot be manipulated to perform different logical operations that they did originally. A hard core may be itself comprised of multiple hard cores, because circuits are often organized hierarchically such that multiple subcomponents make up the higher level component.

Soft Core—A soft core is reconfigurable. Thus, the soft core can be adjusted after it has been manufactured and initially configured, such that it carries out different logical operations than it originally did. A soft core may itself be comprised of multiple soft cores.

Virtual processor—An independent hardware thread that can execute its own program, or the same program currently being executed by one or more other hardware threads. The virtual processors resemble independent processor cores; however, multiple hardware threads share the physical hardware resources of a single core. For example, a processor core implementing a pipeline comprising 8 stages may implement 8 independent hardware threads, each running at an effective rate that is one eighth the clock speed of the frequency at which the processor core operates. The processor core may implement one floating point multiplier unit, however each of the threads can utilize the multiplier unit and are not restricted in their use of the unit regardless of whether the other virtual processors are also using the same unit. Virtual processors have their own separate register sets including special registers such as the program counter, which allows them to execute completely different programs.

### DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, an integrated circuit having a hard core and a soft core is presented. The following description of a parallel computing architecture is one example of an architecture that may be used to implement the hard core of the integrated circuit. The architecture is further described in U.S. Patent Application Publication No. 2009/0083263 (Felch et al.), which is incorporated herein by reference.

Parallel Computing Architecture

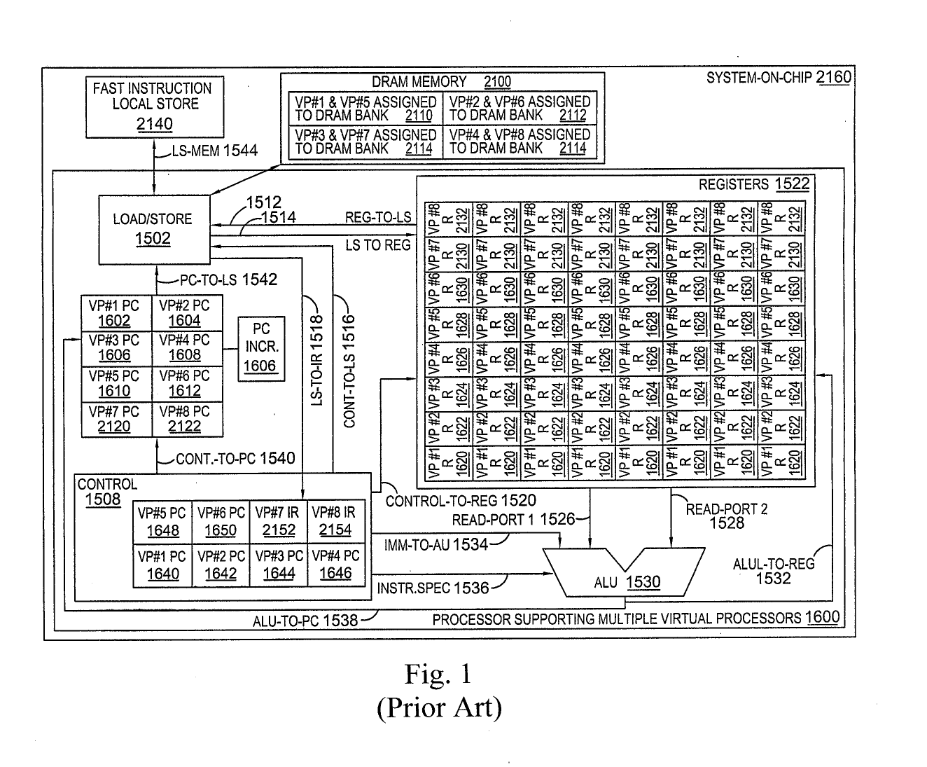

FIG. 1 is a block diagram schematic of a processor architecture 2160 utilizing on-chip DRAM(2100) memory storage as the primary data storage mechanism and Fast Instruction Local Store, or just Instruction Store, 2140 as the primary memory from which instructions are fetched. The Instruction Store 2140 is fast and is preferably implemented using SRAM memory. In order for the Instruction Store 2140 to not consume too much power relative to the microprocessor and DRAM memory, the Instruction Store 2140 can be made very small. Instructions that do not fit in the SRAM are stored in and fetched from the DRAM memory 2100. Since instruction fetches from DRAM memory are significantly slower than from SRAM memory, it is preferable to store performance-critical code of a program in SRAM. Performance-critical code is usually a small set of instructions that are repeated many times during execution of the program.

The DRAM memory 2100 is organized into four banks 2110, 2112, 2114 and 2116, and requires 4 processor cycles to complete, called a 4-cycle latency. In order to allow such instructions to execute during a single Execute stage of the Instruction, eight virtual processors are provided, including new VP#7 (2120) and VP#8 (2122). Thus, the DRAM memories 2100 are able to perform two memory operations for every Virtual Processor cycle by assigning the tasks of two processors (for example VP#1 and VP#5 to bank 2110). By elongating the Execute stage to 4 cycles, and maintaining single-cycle stages for the other 4 stages comprising: Instruction Fetch, Decode and Dispatch, Write Results, and Increment PC; it is possible for each virtual processor to complete an entire instruction cycle during each virtual processor cycle. For example, at hardware processor cycle T=1 Virtual Processor #1 (VP#1) might be at the Fetch instruction cycle. Thus, at T=2 Virtual Processor #1 (VP#1) will perform a Decode & Dispatch stage. At T=3 the Virtual Processor will begin the Execute stage of the instruction cycle, which will take 4 hardware cycles (half a Virtual Processor cycle since there are 8 Virtual Processors) regardless of whether the instruction is a memory operation or an ALU 1530 function. If the instruction is an ALU instruction, the Virtual Processor might spend cycles 4, 5, and 6 simply waiting. It is noteworthy that although the Virtual Processor is waiting, the ALU is still servicing a different Virtual Processor (processing any non-memory instructions) every hardware cycle and is preferably not idling. The same is true for the rest of the processor except the additional registers consumed by the waiting Virtual Processor, which are in fact idling. Although this architecture may seem slow at first glance, the hardware is being fully utilized at the expense of additional hardware registers required by the Virtual Processors. By minimizing the number of registers required for each Virtual Processor, the overhead of these registers can be reduced. Although a reduction in usable registers could drastically reduce the performance of an architecture, the high bandwidth availability of the DRAM memory reduces the penalty paid to move data between the small number of registers and the DRAM memory.

This architecture 1600 implements separate instruction cycles for each virtual processor in a staggered fashion such that at any given moment exactly one VP is performing Instruction Fetch, one VP is Decoding Instruction, one VP is Dispatching Register Operands, one VP is Executing Instruction, and one VP is Writing Results. Each VP is performing a step in the Instruction Cycle that no other VP is doing. The entire processor's 1600 resources are utilized every cycle. Compared to the naïve processor 1500 this new processor could execute instructions six times faster.

As an example processor cycle, suppose that VP#6 is currently fetching an instruction using VP#6 PC 1612 to designate which instruction to fetch, which will be stored in VP#6 Instruction Register 1650. This means that VP#5 is Incrementing VP#5 PC 1610, VP#4 is Decoding an instruction in VP#4 Instruction Register 1646 that was fetched two cycles earlier. VP #3 is Dispatching Register Operands. These register operands are only selected from VP#3 Registers 1624. VP#2 is Executing the instruction using VP#2 Register 1622 operands that were dispatched during the previous cycle. VP#1 is Writing Results to either VP#1 PC 1602 or a VP#1 Register 1620.

During the next processor cycle, each Virtual Processor will move on to the next stage in the instruction cycle. Since VP#1 just finished completing an instruction cycle it will start a new instruction cycle, beginning with the first stage, Fetch Instruction.

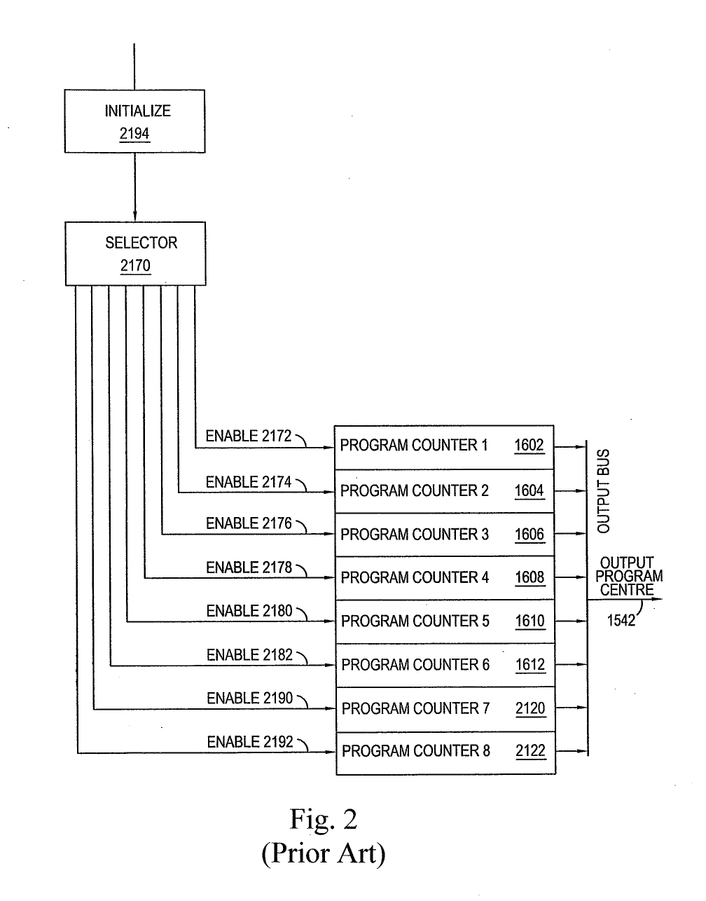

Note, in the architecture 2160, in conjunction with the additional virtual processors VP#7 and VP#8, the system control 1508 now includes VP#7 IR 2152 and VP#8 IR 2154. In addition, the registers for VP#7 (2132) and VP#8 (2134) have been added to the register block 1522. Moreover, with reference to FIG. 2, a Selector function 2110 is provided within the control 1508 to control the selection operation of each virtual processor VP#1-VP#8, thereby maintaining the orderly execution of tasks/threads, and optimizing advantages of the virtual processor architecture the has one output for each program counter and enables one of these every cycle. The enabled program counter will send its program counter value to the output bus, based upon the direction of the selector 2170 via each enable line 2172, 2174, 2176, 2178, 2180, 2182, 2190, 2192. This value will be received by Instruction Fetch unit 2140. In this configuration the Instruction Fetch unit 2140 need only support one input pathway, and each cycle the selector ensures that the respective program counter received by the Instruction Fetch unit 2140 is the correct one scheduled for that cycle. When the Selector 2170 receives an initialize input 2194, it resets to the beginning of its schedule. An example schedule would output Program Counter 1 during cycle 1, Program Counter 2 during cycle 2, etc. and Program Counter 8 during cycle 8, and starting the schedule over during cycle 9 to output Program Counter 1 during cycle 9, and so on . . . A version of the selector function is applicable to any of the embodiments described herein in which a plurality of virtual processors are provided.

To complete the example, during hardware-cycle T=7 Virtual Processor #1 performs the Write Results stage, at T=8 Virtual Processor #1 (VP#1) performs the Increment PC stage, and will begin a new instruction cycle at T=9. In another example, the Virtual Processor may perform a memory operation during the Execute stage, which will require 4 cycles, from T=3 to T=6 in the previous example. This enables the architecture to use DRAM 2100 as a low-power, high-capacity data storage in place of a SRAM data cache by accommodating the higher latency of DRAM, thus improving power-efficiency. A feature of this architecture is that Virtual Processes pay no performance penalty for randomly accessing memory held within its assigned bank. This is quite a contrast to some high-speed architectures that use high-speed SRAM data cache, which is still typically not fast enough to retrieve data in a single cycle.

Each DRAM memory bank can be architected so as to use a comparable (or less) amount of power relative to the power consumption of the processor(s) it is locally serving. One method is to sufficiently share DRAM logic resources, such as those that select rows and read bit lines. During much of DRAM operations the logic is idling and merely asserting a previously calculated value. Using simple latches in these circuits would allow these assertions to continue and free-up the idling DRAM logic resources to serve other banks. Thus the DRAM logic resources could operate in a pipelined fashion to achieve better area efficiency and power efficiency.

Another method for reducing the power consumption of DRAM memory is to reduce the number of bits that are sensed during a memory operation. This can be done by decreasing the number of columns in a memory bank. This allows memory capacity to be traded for reduced power consumption, thus allowing the memory banks and processors to be balanced and use comparable power to each other.

The DRAM memory 2100 can be optimized for power efficiency by performing memory operations using chunks, also called “words”, that are as small as possible while still being sufficient for performance-critical sections of code. One such method might retrieve data in 32-bit chunks if registers on the CPU use 32-bits. Another method might optimize the memory chunks for use with instruction Fetch. For example, such a method might use 80-bit chunks in the case that instructions must often be fetched from data memory and the instructions are typically 80 bits or are a maximum of 80 bits.

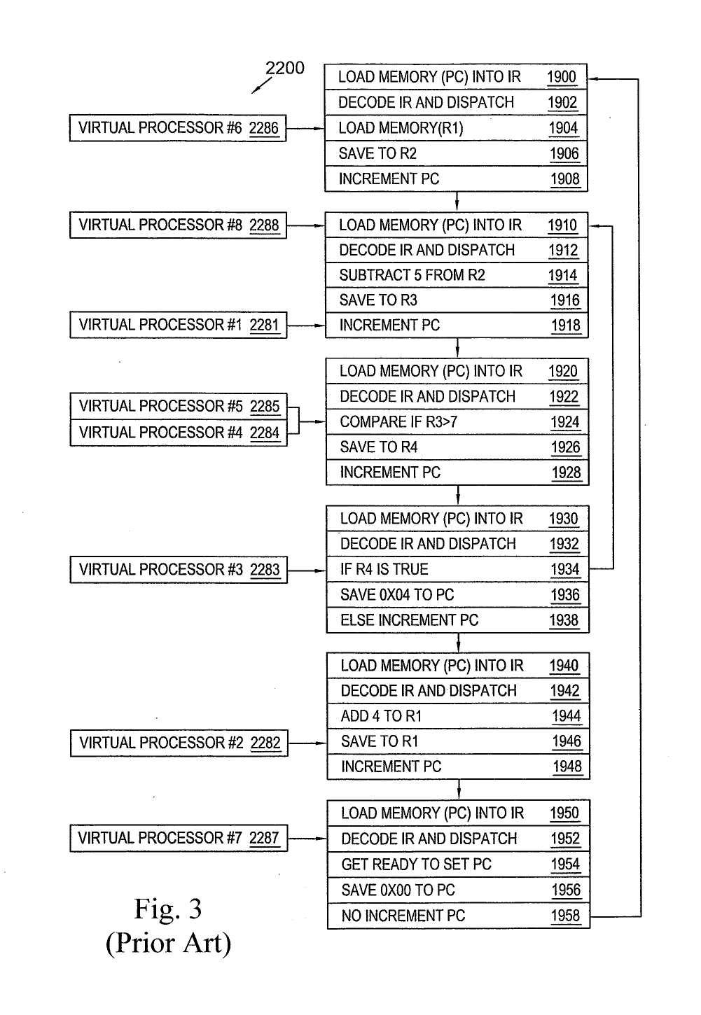

FIG. 3 is a block diagram 2200 showing an example state of the architecture 2160 in FIG. 1. Because DRAM memory access requires four cycles to complete, the Execute stage (1904, 1914, 1924, 1934, 1944, 1954) is allotted four cycles to complete, regardless of the instruction being executed. For this reason there will always be four virtual processors waiting in the Execute stage. In this example these four virtual processors are VP#3 (2283) executing a branch instruction 1934, VP#4 (2284) executing a comparison instruction 1924, VP#5 2285 executing a comparison instruction 1924, and VP#6 (2286) a memory instruction. The Fetch stage (1900, 1910, 1920, 1940, 1950) requires only one stage cycle to complete due to the use of a high-speed instruction store 2140. In the example, VP#8 (2288) is in the VP in the Fetch Instruction stage 1910. The Decode and Dispatch stage (1902, 1912, 1922, 1932, 1942, 1952) also requires just one cycle to complete, and in this example VP#7 (2287) is executing this stage 1952. The Write Result stage (1906, 1916, 1926, 1936, 1946, 1956) also requires only one cycle to complete, and in this example VP#2 (2282) is executing this stage 1946. The Increment PC stage (1908, 1918, 1928, 1938, 1948, 1958) also requires only one stage to complete, and in this example VP#1 (1981) is executing this stage 1918. This snapshot of a microprocessor executing 8 Virtual Processors (2281-2288) will be used as a starting point for a sequential analysis in the next figure.

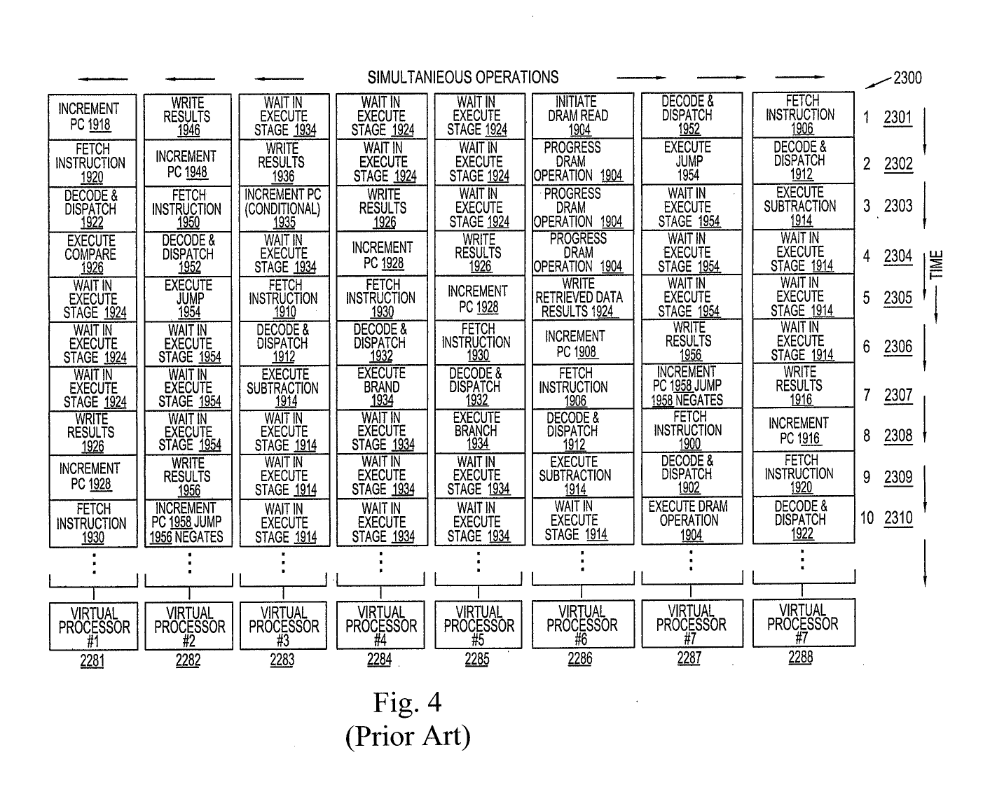

FIG. 4 is a block diagram 2300 illustrating 10 cycles of operation during which 8 Virtual Processors (2281-2288) execute the same program but starting at different points of execution. At any point in time (2301-2310) it can be seen that all Instruction Cycle stages are being performed by different Virtual Processors (2281-2288) at the same time. In addition, three of the Virtual Processors (2281-2288) are waiting in the execution stage, and, if the executing instruction is a memory operation, this process is waiting for the memory operation to complete. More specifically in the case of a memory READ instruction this process is waiting for the memory data to arrive from the DRAM memory banks This is the case for VP#8 (2288) at times T=4, T=5, and T=6 (2304, 2305, 2306).

When virtual processors are able to perform their memory operations using only local DRAM memory, the example architecture is able to operate in a real-time fashion because all of these instructions execute for a fixed duration.

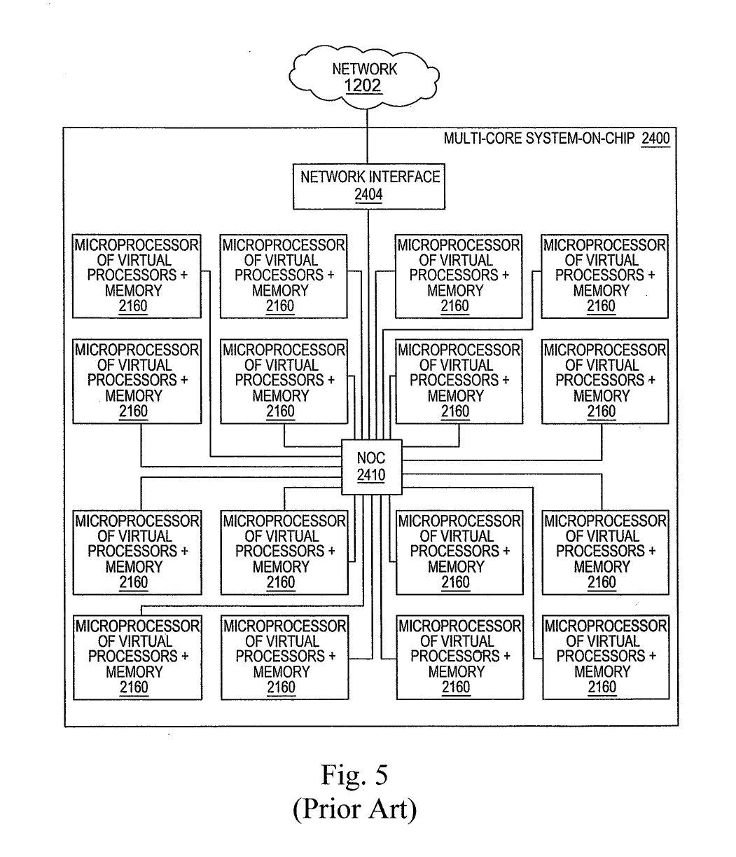

FIG. 5 is a block diagram of a multi-core system-on-chip 2400. Each core is a microprocessor implementing multiple virtual processors and multiple banks of DRAM memory 2160. The microprocessors interface with a network-on-chip (NOC) 2410 switch such as a crossbar switch. The architecture sacrifices total available bandwidth, if necessary, to reduce the power consumption of the network-on-chip such that it does not impact overall chip power consumption beyond a tolerable threshold. The network interface 2404 communicates with the microprocessors using the same protocol the microprocessors use to communicate with each other over the NOC 2410. If an IP core (licensable chip component) implements a desired network interface, an adapter circuit may be used to translate microprocessor communication to the on-chip interface of the network interface IP core.

The Hybrid Processor Core

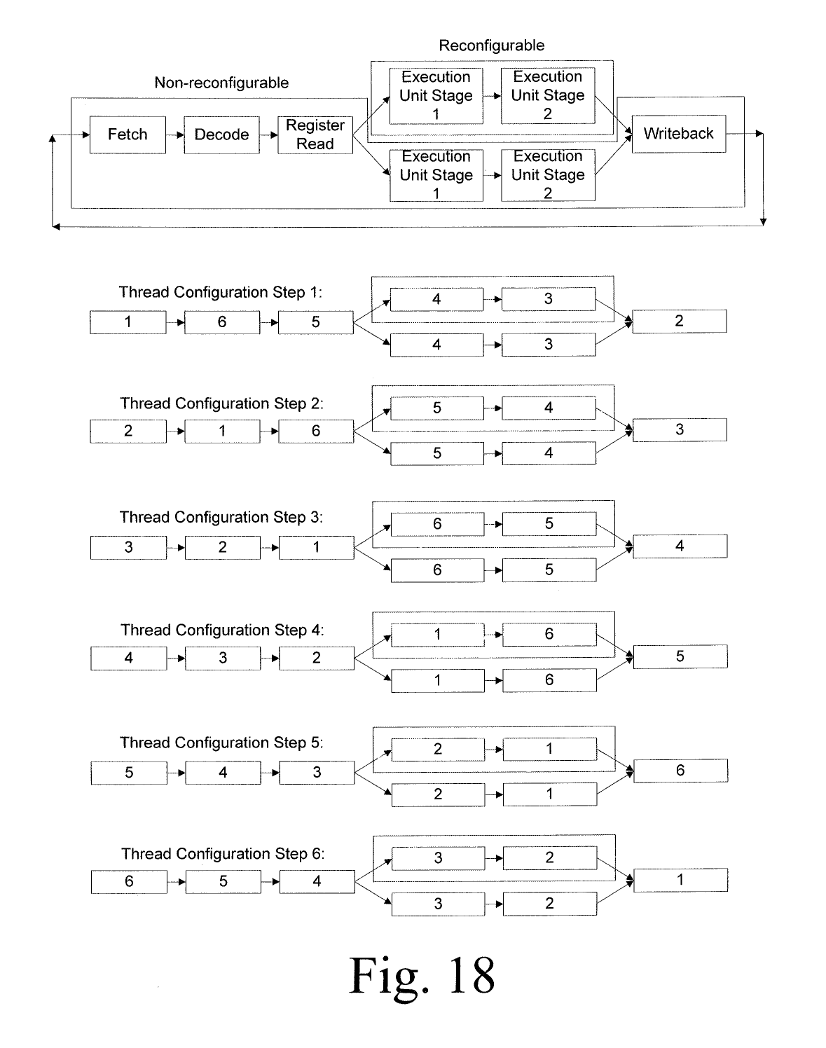

FIG. 18 shows an illustrative embodiment of a hybrid system of the preferred embodiment having a hard core implementing a pipeline and a soft core implementing an execution unit. In the first row, an integrated circuit having both a non-reconfigurable multi-threaded processor core (also called a “hard core”) implementing an execution pipeline and a reconfigurable subcomponent implementing the stages of an execution unit are shown. Generally, the reconfigurable subcomponent is implemented in reconfigurable hardware such as a Field Programmable Gate Array (“FPGA”), Complex Programmable Logic Device (“CPLD”) or the like. The reconfigurable subcomponent allows for executing one or more custom instructions that are not part of the instruction set of the non-reconfigurable multi-threaded processor core.

The multi-threaded nature of the processor core allows the execution stage to use multiple clock cycles to complete without penalizing performance. rows 2-7 of FIG. 18 illustrate the multithreaded nature of the core. In step 1 (row 2), thread #1 is in the Fetch stage, thread #6 is in decode stage, etc. In step 2 (row 3), thread #1 is in the decode stage and thread #6 is in the Register Read stage. This proceeds for steps 3-6 (rows 4-7) so that the six threads are executing simultaneously, each using a different portion of the processor at any given moment. Because reconfigurable components cannot complete the same amount of calculations per cycle as non-reconfigurable processor cores, multiple reconfigurable execution stages will typically be required to implement useful custom instructions.

The ability of the user to implement different custom instructions in the reconfigurable component provides several advantages. For example, the reconfigurable subcomponent allows the user to keep custom instructions private and allows programs to use instructions that require private data without providing that data to the program by storing the data inside the reconfigurable circuitry.

Several hybrid processor cores are known. For example, XILINX offers a processor having a hard core and soft core on the same chip die and INTEL offers a processor having a hard core and soft core on separate dies in the same package. Another hybrid processing core, described in “Coupling of a reconfigurable architecture and a multithreaded processor core with integrated real-time scheduling” by Uhrig et al is the CarCore. In the CarCore, the reconfigurable portion of the chip is a Molen organization. The Molen organization provides the reconfigurable module with independent access to memory, whereas the present invention does not. In contrast to the CarCore, the soft core of the present invention is restricted to implementing a reconfigurable ALU. Furthermore, only one hardware thread can execute operations within the reconfigurable module in the CarCore/Molen architecture whereas the present invention allows all threads access to executing instructions carried out by the reconfigurable hardware. Put another way, one difference between the CarCore and the present invention is that all instructions share the reconfigurable hardware and by using the reconfigurable hardware a hardware thread does not exclude other hardware threads from using it. Finally, specialized registers are accessible by the reconfigurable module in the CarCore/Molen architecture, whereas the present invention allows the reconfigurable module to read and write values to and from the general purpose registers available to any other instruction (reconfigurable or not).

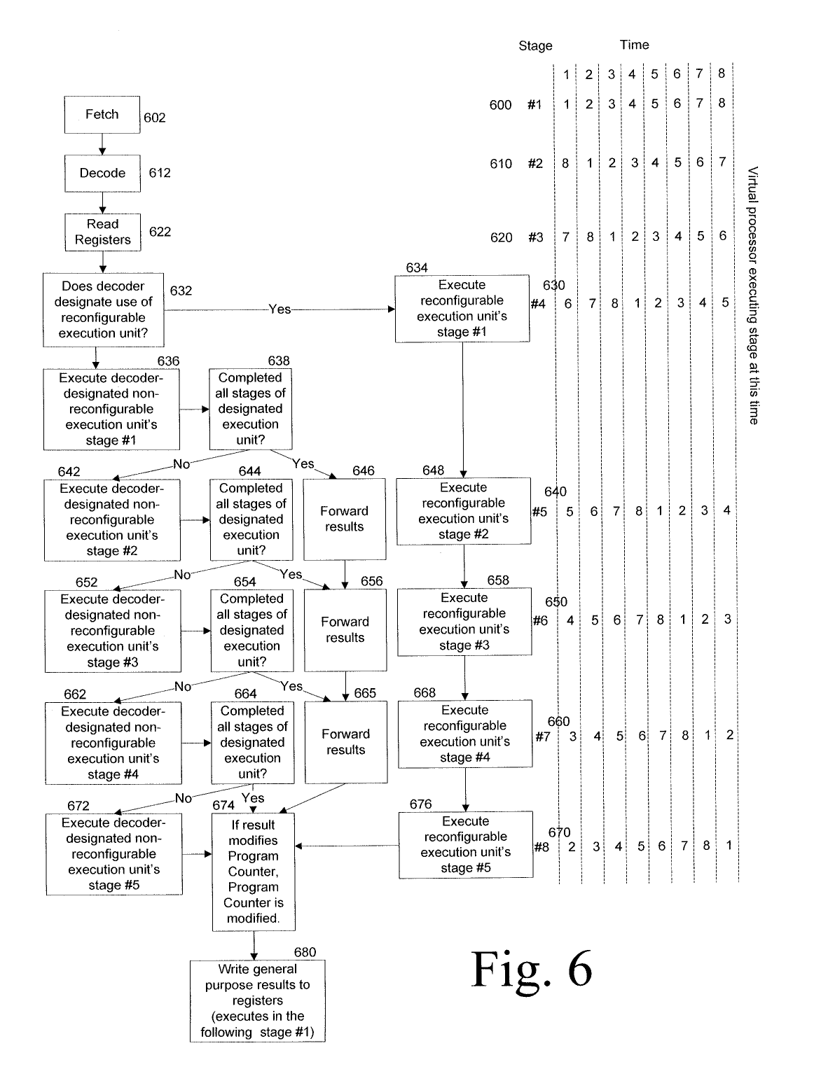

FIG. 6 shows an illustrative embodiment of operation of a virtual processor using a reconfigurable execution unit. The table on the right shows at which stage each of the eight virtual processors is executing at a given moment. For example, the column with header “1”, shows which virtual processor is executing stage #1, #2, . . . #8 from top to bottom of that column. Stage #1 executes virtual processor (VP) 1 at time=1, VP2 at time=2, VP3 at time=3, . . . VP8 at time=8. A stage comprises all of the processing steps to the left of the stage label. For example, stage #1 comprises the Fetch step 602. In stage 2, at time=2, VP1 is executing the step 612 of decoding the instruction that was fetched in the previous stage.

At time=3, VP1 is executing stage #3. Stage #3 comprises step 622 of reading the registers from the register file as designated by the instruction decoded in the previous stage at time=2. At time=4, VP1 is executing stage #4 and at step 632 examines whether the decoder has determined that the instruction designates the use of the reconfigurable unit. If so, at step 634, the reconfigurable execution unit stage #1 is performed and the execution of VP1 proceeds to stage #2 at time=5. If the decoder does not designate the use of the reconfigurable execution unit, then at step 636 execution proceeds to stage #1 of a non-reconfigurable execution unit. If at step 638 the designated non-reconfigurable execution unit comprises only one stage of processing then VP1 proceeds to step 646 at time=5. If the designated non-reconfigurable execution unit has a second stage then VP1 proceeds to step 642 at time=5.

At time=5, VP1 executes stage 5. If VP1 is at step 648, then the second stage of the reconfigurable execution unit is performed and VP1 proceeds to step 658 at time=6. If VP1 is at step 646, then the results of the previously executed non-reconfigurable execution unit are forwarded and VP1 proceeds to step 656 at time=6. If VP1 is at step 642, then stage #2 of the designated non-reconfigurable execution unit is executed and VP1 proceeds to step 644. Step 644 proceeds to step 656 at time=6 if the designated execution unit has only two stages, but if it has more than 2 stages then VP1 proceeds to step 652 at time=6.

At time=6, VP1 executes stage 6. If VP1 is at step 658 then the third stage of the reconfigurable execution unit is performed and VP1 proceeds to step 668 at time=7. If VP1 is at step 656 then the results of the previously executed non-reconfigurable execution unit are forwarded and VP1 proceeds to step 665 at time=7. If VP1 is at step 652 then stage #3 of the designated non-reconfigurable execution unit is executed and VP1 proceeds to step 654. Step 654 proceeds to step 665 at time=7 if the designated execution unit has only 3 stages, but if it has more than 3 stages then VP1 proceeds to step 662 at time=7.

At time=7, VP1 executes stage 7. If VP1 is at step 668 then the fourth stage of the reconfigurable execution unit is performed and VP1 proceeds to step 676 at time=8. If VP1 is at step 665 then the results of the previously executed non-reconfigurable execution unit are forwarded and VP1 proceeds to step 674 at time=8. If VP1 is at step 662 then stage #4 of the designated non-reconfigurable execution unit is executed and VP1 proceeds to step 664. Step 664 proceeds to step 674 at time=8 if the designated execution unit has only 4 stages, but if it has more than 4 stages then VP1 proceeds to step 672 at time=8.

At time=8, VP1 executes stage 8. If VP1 is at step 676 then the fifth stage of the reconfigurable execution unit is performed and VP1 proceeds to step 674. At time=8, if VP1 is at step 672 then stage #5 of the designated non-reconfigurable execution unit is executed and VP1 proceeds to step 674.

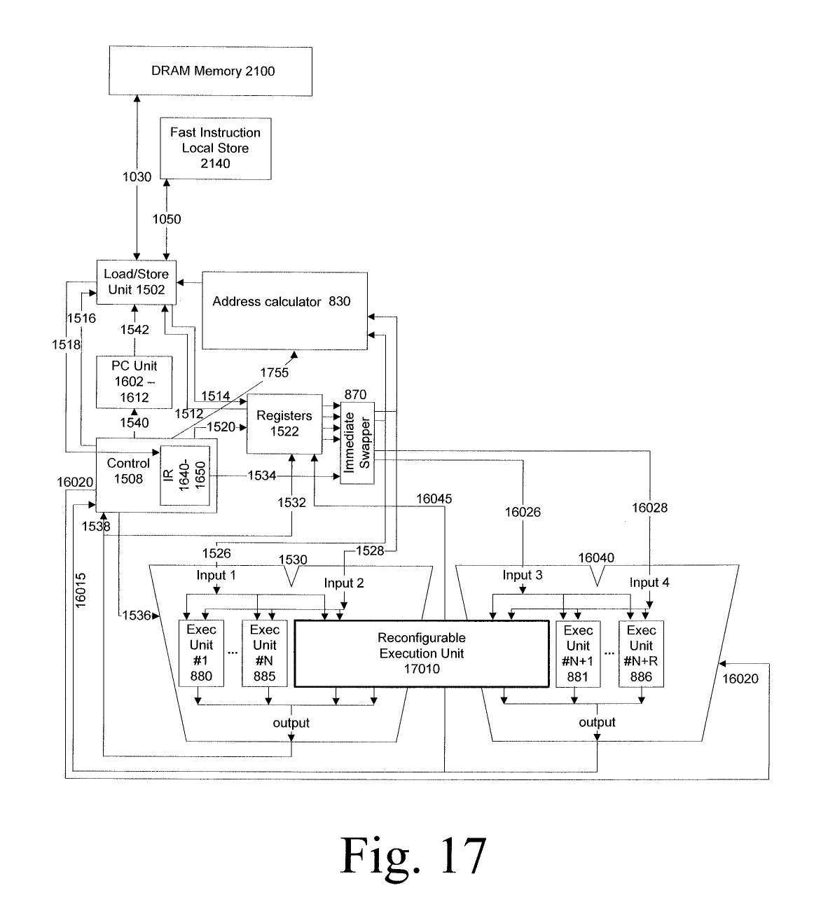

All the previous steps lead to step 674, executed by VP1 at time=8. At step 674, if the instruction that had been previously decoded designates that the result is to be written to the program counter (or added to it) then this is done in order to affect the Fetch stage that will occur at time=9. From step 674 execution proceeds to step 680 at time=9, where the general purpose results are written back to the register file (this may alternatively be delayed an additional cycle, waiting for stage #2, or alternatively the writing process can be stretched across stage #1 and stage #2, e.g. if two results are being written back as in the case of the Long-Instruction-Word described below with respect to FIG. 17).

At time t=9, VP1 resumes execution at the stage #1, where at step 602 a Fetch for new instruction is performed and the process of FIG. 6 begins again for the new instruction that is designated by the program counter. The program counter has either been incremented to the subsequent instruction (or instruction bundle in the case of Long-Instruction-Words), or modified by the result in step 674 to point to a different instruction. It can be seen that at any given point in time, each stage is executing a particular virtual processor so that no stage is left idling. In addition, 5 stages have been provided for the reconfigurable execution unit, which is a substantial number of cycles, which enables the reconfigurable core (described in the subsequent figure), which is not as high performance as the non-reconfigurable core, to do a substantial amount of work. Typically, a high latency instruction, which requires 5 cycles to complete, would hurt performance, but in the present system the virtual processors' inherent latency allows for the reconfigurable units to do useful work.

While the above embodiment was described with five stages of execution, in alternate embodiments, a reconfigurable unit may have additional execution stages, for example between 6 and 13 stages. In this case the architecture can be modified (and additional resources such as program counter and register file capacity added) to accommodate more virtual processors. Thus, a system having 16 virtual processors may accommodate reconfigurable units with as many as 13 stages.

One method of implementing high latency instructions, such as a 13-stage reconfigurable unit, may be to implement those stages in the reconfigurable execution unit. The reconfigurable execution unit which can be programmed with an arbitrary number of stages since the forwarding of results is performed internally to the reconfigurable execution unit. In this case, the results in stage #8 could be garbage since the reconfigurable execution unit will not have completed its task. However it is also possible to write the results to, for example, a non-modifiable register, such as register zero (which can be made to always hold the value zero), so that the results do not affect a register. If the trailing instruction(s) move the result from the 13^{th} reconfigurable execution (8 additional stages beyond stage #5, which leaves the virtual processors in synch) unit onto steps 674 and 680 of FIG. 6, then the results will be written properly to the register file. Note that a Program-counter-modifying instruction cannot be correctly implemented in this way because the garbage returned during the first stage #8 would have altered the execution path. The trailing instructions would themselves initiate a second execution of the reconfigurable execution unit, however the results of that execution will not be used. In fact, if it is desired to run the same instruction again, the second initiated execution can be used by a further trailing instruction(s).

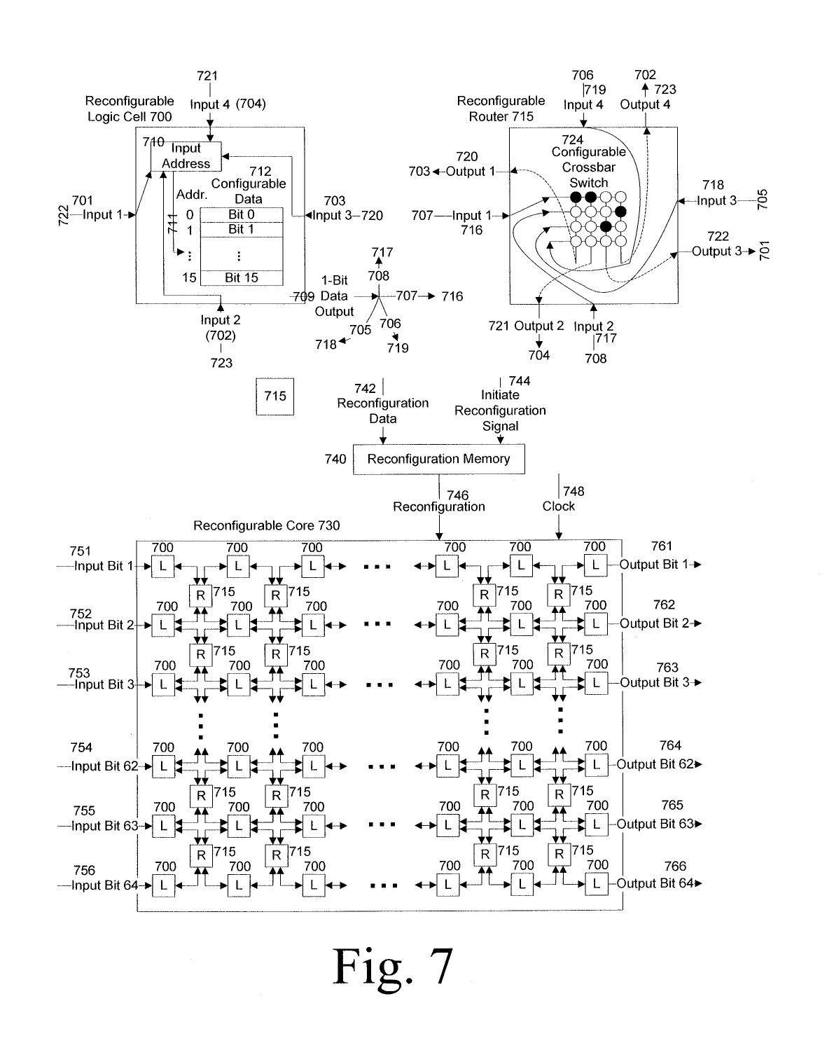

Referring now to FIG. 7, a reconfigurable core 730, comprising many reconfigurable logic cells 700 interconnected with many reconfigurable routers 715 is shown. The reconfigurable core 730 is one example of a reconfigurable core; however, many other types of organizations of reconfigurable cores are within the scope of this invention. For example, reconfigurable cores having logic cells with more or fewer inputs and different connection distributions of the reconfigurable routers 715. In addition, the links from router to router and logic cell to logic cell may be direct.

The reconfigurable logic cell 700 has four inputs 701, 702, 703, and 704, each of which are connected to the outputs 722, 723, 720, 721 of a reconfigurable router 715, respectively, in this illustrative embodiment. The inputs are single bits and are joined together in the Input Address 710, which creates a 4-bit index. A value will be fetched from the Configurable Data table 712 at the address indicated by the created index. The bit that is fetched is output via connection 709 to four output ports (each outputting the same bit, i.e. either all zero, or all one) 705, 706, 706, 708. These outputs connect to the inputs of a unit 715 via connections 718, 719, 716, 717 respectively.

The outputs of the reconfigurable logic cell 700 are received by inputs of connected reconfigurable routers 715 at one of the input ports 716, 717, 718, or 719. The reconfigurable router has four output ports 720, 721, 722 and 723. The output is generated in the configurable crossbar switch 724, which receives input from all four inputs 716, 717, 718 and 719 to the reconfigurable router 715. Each output can be connected to any of the inputs. In FIG. 7, the configurable crossbar switch 724 is configured to connect input 1 to output 1 and output 2. Given this connection, if input 1 is zero, then output 1 and output 2 are set to zero. If input 1 is one, then output 1 and output 2 are set to one. These connections are indicated by the filled in circles, where as the empty circles indicate points at which a connection could have been made but wasn't. This example also connects input 2 to output 4 in the configurable crossbar switch 724, and input 3 to output 3.

The reconfigurable core 730 is blank and carries out no functions until it has been reconfigured. The reconfiguration data arrives via connection 742 to the reconfiguration memory 740. The origin of the connection 742 may be the memory bus of the local processing core, such that the local processing core can execute memory write operations to write a piece of data to memory. The memory bus intercepts the address, interprets it as an address which resides in the reconfiguration memory 740, and routes the data to the reconfigurable data connection 742. The initiate reconfiguration signal 744 is typically set to “off”, but results in the reconfiguration data held in reconfiguration memory 740 being inserted into the reconfigurable core 730 when set to “on”. This reprograms the configurable data tables 712 and configurable crossbar switches 724 of all the reconfigurable logic cells 700 and reconfigurable routers 715 via the reconfiguration connection 746. Other components, such as 16×16 multipliers or multi-kilobyte block rams may also reside and be configurable and routable within the reconfigurable core 730.

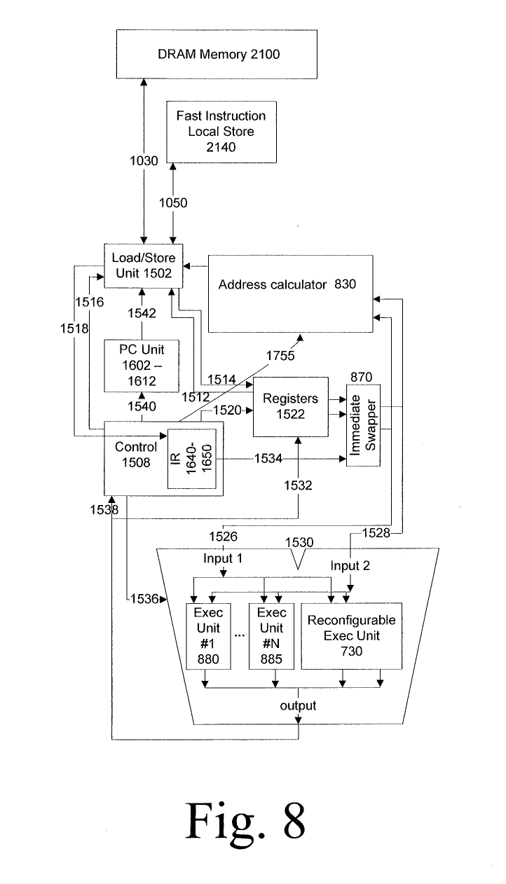

The number of stages implemented in the reconfigurable core is implied by the configuration. Therefore, before reconfiguration it is impossible to point at particular logic cells as holding data transitioning from one stage to another, or to know how many stages are in fact being implemented (although this example assumes 5 stages). The number of stages that are implemented must be a number that delivers results to the output bus in the final stage of execution. Thus it could implement 5, 13, or 21 stages, but not 4 or 6 stages. Stage counts of 4 and 6 are disallowed because the results would be out of phase with the virtual processor that issued the instruction to the reconfigurable core. If more than 5-stages are implemented in the reconfiguration of the reconfigurable core 730, then trailing instructions (subsequently fetched instructions that are fetched before the result from the previous instruction is ready) must connect the output of the reconfigurable core 761, 762, 763, . . . , 764, 765, 766 to the ALU output bus (see FIG. 8). The inputs to the reconfigurable core arrive during the register read stage 620, 622 and are usable in the next stage, stage #4 of FIG. 6.

The clock 748 is provided to the reconfigurable core 730 and can be routed to logic cells to enable their outputs to change only once the clock signal changes, thereby implementing a transition from a previous stage to a subsequent stage, enabling the implementation of stages inherent in the configuration.

It is noteworthy that the number of inputs 751-756 to the reconfigurable core 730 is shown to be 64 bits in the illustrative example however fewer, such as 32 bits, or more, such as 128 bits, could also be used. In addition, two sets of 64-bit inputs (each 64-bit input comprising two 32-bit inputs) can be used with a reconfigurable core 730 to implement reconfigurable execution units for multiple arithmetic logic units, as shown in FIG. 17. Similarly, the outputs 761-766 may 64 bits or may be variable, e.g. 32 bits, 128 bits. Also, the layout of the reconfigurable core is not meant to be restricted to a horizontal rectangle where opposite sides have inputs and outputs, it is possible that nonrectangular layouts are able to effectively use available die area (and possibly use die area that would otherwise be unused or used suboptimally).

FIG. 8 is a block diagram schematic of the processor architecture 2160 of FIG. 1. An address calculator 830 has been added, which brings address data from the Immediate Swapper 870 to the Load/Store Unit 1502. The Immediate Swapper 870 passes data from the Registers 1522 to the Address Calculator 830, unless the Control Unit 1508 designates that data from the Instruction Registers (called “immediate”) 1640-1650 should replace certain data fetched from the Registers 1522. The entire architecture in FIG. 8, with the exception of the reconfigurable execution unit 730, is a non-reconfigurable “Hard Core”, including the N execution units 880-885 residing within the Arithmetic Logic Unit 1530. The reconfigurable execution unit 730 is preferably the only portion of the architecture that is reconfigurable. The reconfigurable execution unit 730 receives inputs via connections 1526 and 1528, and sends output to the output bus, which is controlled by Control 1508 via the connection 1536 to direct output from the proper execution unit 880-885 or 730 to the proper destination register via connection 1532 or to update the program counter via connection 1538.

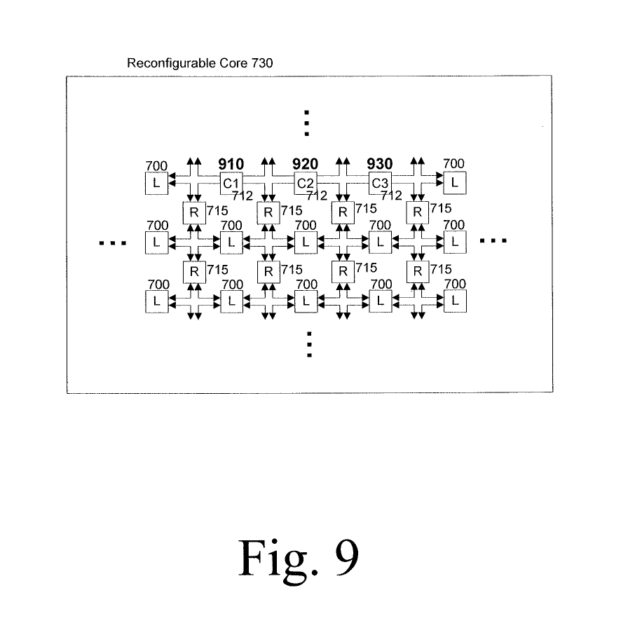

FIG. 9 is a block diagram of the reconfigurable core 730 showing the storage of private data in the reconfigurable core in accordance with a preferred embodiment of this invention. Values C1 910, C2 920, and C3 930 store three separate bits of data within the configurable data tables 712 of reconfigurable core 730. The data is called a “constant” and is set at the time of reconfiguration in this example. It is possible that a program executing on a virtual processor that can execute instructions that use the reconfigurable core 730 may not directly access the constant data 910-930. This could be useful, for example, if the reconfigurable core can carry out encryption and the encryption key is held as constant data within the reconfigurable core. In this way it would be especially difficult for a security attack to retrieve the encryption key even if the attacker is able to run their own programs on the virtual processor. Thus the constant data held in 910-930 can be considered private data.

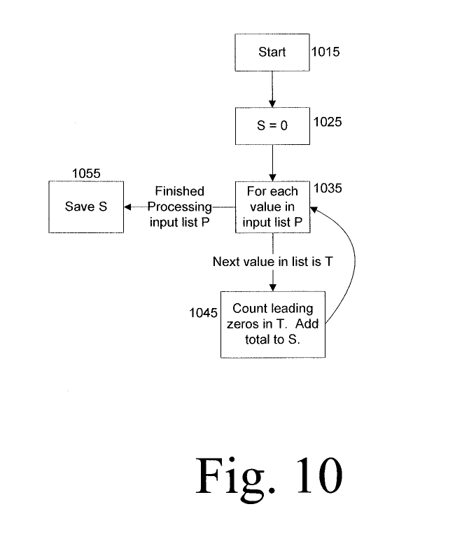

FIG. 10 shows a program that may be executed on the hardware of FIG. 8. The starts at step 1015 and immediately proceeds to step 1025, wherein the value S is set to zero. The program next performs step 1035, where an iterative loop shown in steps 1035-1045 is initiated. The values in the input list P are iterated through, and in step 1045 the current value is analyzed such that the “leading zeros” are counted. Leading zeros are zeros that occur in the most significant portions of a value for which the value has no higher one bits. For example, for a 32-bit number, 0x00FFFFFF has 8 leading zeros. 0x0000FFFF has 16 leading zeros, 0x000000FF has 24 leading zeros, 0x8ea2F153 has no leading zeros, and 0x00000000 has 32 leading zeros. The leading zeros in each value of input list P are counted and added to S. Once all values in list P have been processed the program proceeds to save the value S at step 1055 and then ends.

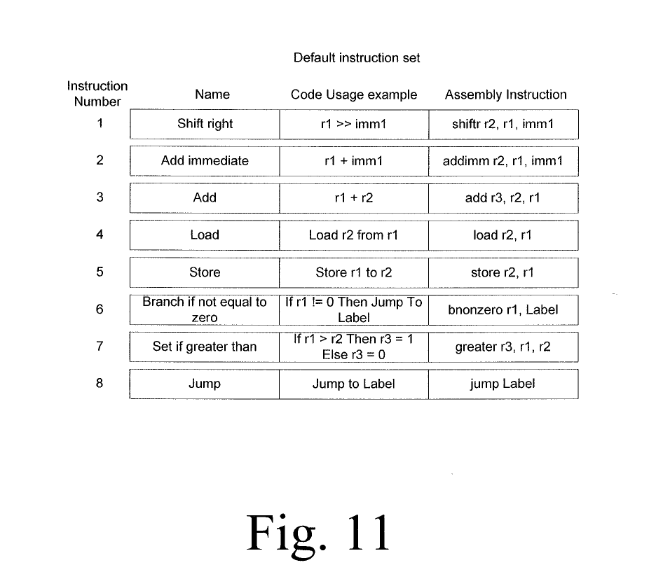

FIG. 11 shows a portion of a default instruction set for executing the program of FIG. 10 on the processing architecture shown in FIG. 8. Eight instructions are shown, corresponding to the eight different rows, designated by the instruction number column. While only eight instructions necessary to run the program of FIG. 10 are shown, instruction sets typically have many more than 8 instructions in the default set. The shift right operation is shown in row 1, and uses symbol r1>>imm1, where r1 is a variable and imm1 is a constant (data included in the instruction data, called an “immediate”), such as “variable>>5”. If variable were equal to 0x0000FFFF before executing such an instruction, then it would become 0x000007FF after the shift (zeros inserted in the 5 most significant places, bits in the 5 least significant places deleted, and bits in positions 32 through 6 moved to positions 27 through 1. Row two shows the “Add immediate instruction, which can add a constant to a variable. Row 3 shows the add instruction, which can add two variables.

Row 4 shows the Load instruction, which can load data from memory, where the data is fetched from the memory at address held in a variable (a variable holding an address is called a “pointer”). The Store instruction is shown in row 5 and operates similar to the Load instruction except data from a variable is saved to memory at the address stored in a variable.

Row 6 shows a branch instruction, where the next step in the program will be at the designated label position unless a variable has a zero value. If the variable has the zero value then execution proceeds to the next instruction, as is the normal case for instructions like Add or Shift. Because the instruction conditionally jumps, it is called a conditional branch. Row 7 shows the “Set if greater than” instruction, which sets a third variable to 1 if a first variable is greater than a second variable, and otherwise sets the third variable to zero. This instruction is useful in preparing to perform a branch such as the instruction of row 6. Row 8 shows the Jump instruction, and is called an “unconditional branch” because the next instruction is at the designated label's position without regard to any variable values.

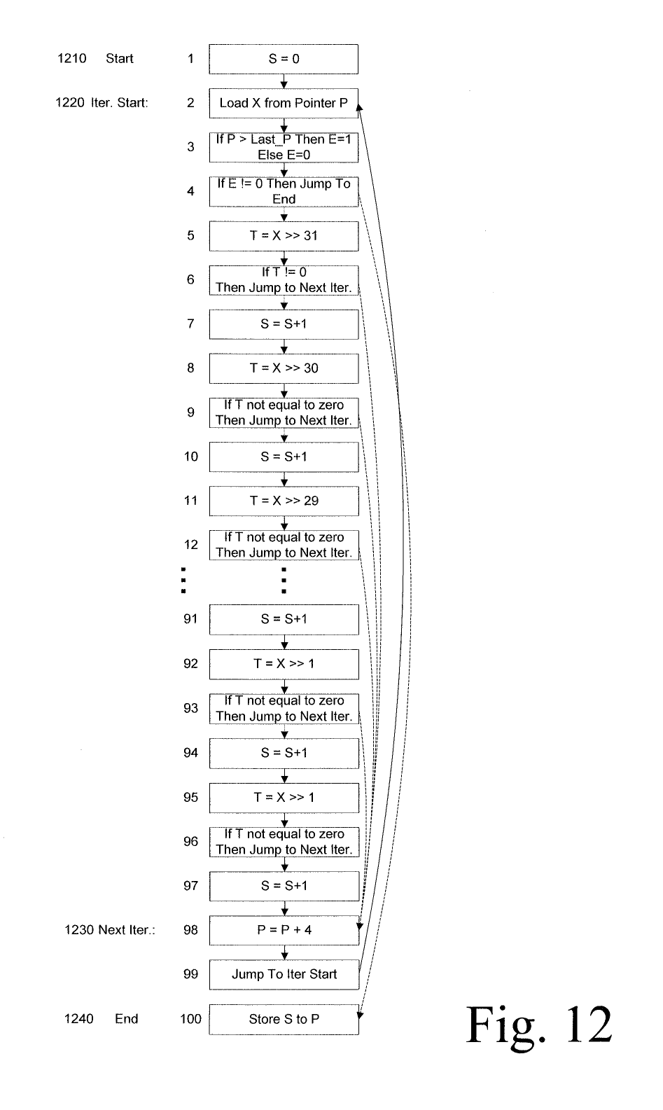

FIG. 12 illustrates an implementation of the program of FIG. 10 with the default instruction set of FIG. 11. Input to the program comprises P, which points to a list of values, and Last_P, which points to the last entry in the list. Output is saved to the data location just after Last_P. The program starts by setting value S to zero. Next, at step 2, a value is loaded from memory at the address indicated by step P into the variable X. Step 2 is also labeled with “Iter. Start”. This label will be jumped to from step 99, as designated by the arrow pointing from step 99 to step 2. In step 3, P is compared with Last_P to determine if P has reached its end. If so, in step 4, execution jumps to step 100, thereby ending the program. If P has not reached its end, execution proceeds to step 5. Steps 5 through 97 comprise a repetition of three instructions designed to add 1 to S until a leading one is found in X. Once the first 1 is found, execution jumps to Next Iter at step 98. If X is equal to zero then execution will flow without any jumps from step 5 to step 97, requiring a significant number of cycles (92) to complete. This can be very inefficient as only one bit is counted for every three cycles.

At step 98, the Next Iter step, P is incremented to point to the next value in the list (assuming 4-byte values) and the loop proceeds from step 99 to step 2 in order to restart. Eventually P will be greater than Last_P and execution will skip from step 4 to End at step 100, wherein S is saved to P (which would point to the data location just after the Last_P address) and execution ends.

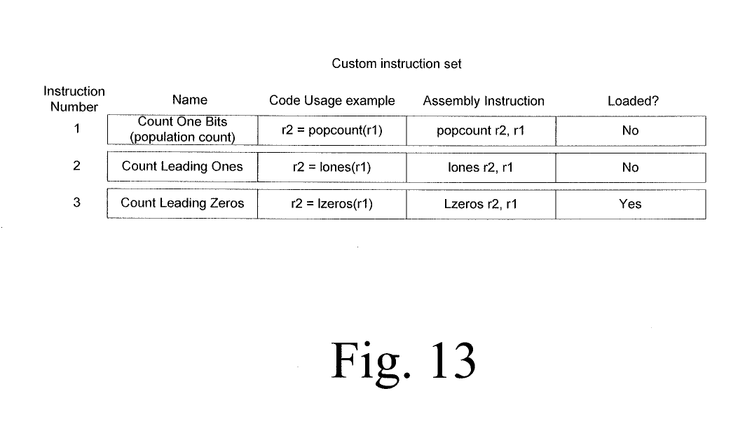

FIG. 13 shows a list of custom instructions that can be loaded into the reconfigurable execution unit 730. Custom instruction 1, in row 1, counts the number of one bits in a variable. This instruction is named “popcount”, as shown in row 1 column 2. For example, popcount(X) where X is equal to 0x0F0F0F0F would result in the value 16 because each of the F's comprise four on bits, and there are four F's in the variable. The hexadecimal zeros of course have no one bits.

Custom instruction 2, in row 2, is the Count Leading Ones instruction, and is identical to the count leading zeros instruction described in the previous two figures, except that leading ones are counted instead of zeros. This instruction is named “lones” as shown in row 2 column 2. The third instruction, in row 3, is the Count Leading Zeros instruction. This instruction is named “lzeros” as shown in row 3 column 2. This instruction is a custom instruction that counts leading zeros and is essentially able to replace steps 5 through 97 in the program of FIG. 12. The “Loaded?” column signifies whether the corresponding instruction will be loaded into the reconfigurable execution unit 730. In FIG. 13, the first two instructions are not going to be loaded into the reconfigurable execution unit 730, but the third custom instruction “Count Leading Zeros” will be loaded.

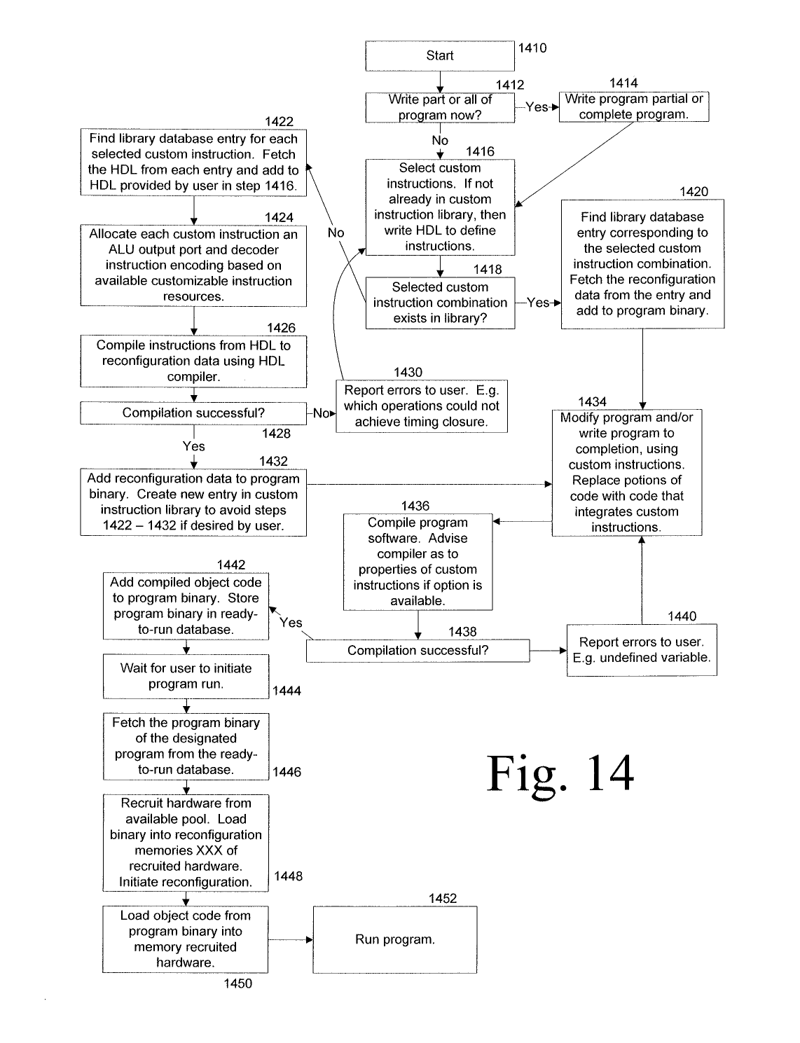

FIG. 14 shows the process by which a user can select custom instructions, write a program using the instructions, compile the program (and possibly instructions), and run the program. The process starts at step 1410 and proceeds to step 1412, where the user decides whether to write all or part of the program before defining custom instructions. If the user decides to write part or all of the program, the process proceeds to step 1414, where the program is written and followed by step 1416. The situation may be one in which part of the program is already written. This situation is also handled by step 1414. If the program will not be written then execution proceeds directly to step 1416, bypassing step 1414. In step 1416 custom instructions are selected by the user. The user can select custom instructions that are already available from a library or can define new custom instructions by writing HDL in such a manner as to receive the inputs and send the outputs from the reconfigurable core 730. The process then proceeds to step 1418 where the specific set of custom instructions is combined and the library is searched for an entry for this combination. If the combination exists the process proceeds to step 1420, where the reconfiguration data is fetched and placed into the program binary, which is followed by step 1434 for modifying or writing the program with the custom instructions.

If at step 1418 no entry exists in the library for the combination of custom instructions selected by the user, then the process proceeds to step 1422. In step 1422, the library is searched for the HDL of each custom instruction that has been selected. This is combined with the HDL written by the user, if any, in step 1416. Optionally, the HDL provided by the user can be uploaded into the database for other users to use or as backup for the HDL data. Next, the process proceeds to step 1424, where each custom instruction is assigned an instruction that is already understood by the decoder. Multiple instructions will be implemented in the decoder that lack hard core execution units so that they can be used with custom instructions. These decoder-implemented custom instructions have different features, for example an instruction named “custom_instruction_1” may allow two variables as input and one variable as output, and use output port X in the ALU 1530 to route results back to the registers 1522. Similarly, “Custom_instruction_2” might allow one variable input, and one immediate (constant) input, and write results to the program counter (or indirectly by outputting an offset to the program counter that will be added to the program counter). In an alternative embodiment, only one output port is provided to the reconfigurable execution unit 730, and the reconfigurable circuits must route the data internal to the reconfigurable execution unit 730 using a signal provided by the Control 1508 to the ALU 1530 and its reconfigurable execution unit 730 via the connection 1536 (See FIG. 8).

Once a set of decodable custom instruction encodings and output ports have been assigned to the custom instructions' HDL codes, the process proceeds to step 1426. In step 1426 the HDL is compiled by the HDL compiler. At step 1428 it is determined whether the compiling was successful and if so, the process proceeds to step 1432 where the reconfiguration data is added to the program binary. Optionally, step 1432 also updates the library database with an entry for the selected combination of custom instructions, which allows future compilations using the same combination of custom instructions to skip steps 1422-1432. The process then proceeds to step 1434.

If it is determined at step 1428 that the compilation is not successful, the process proceeds to step 1430, where the errors are reported to the user. HDL compilation can produce many kinds of errors, some quite complicated, such as timing closure error messages. Another type of error occurs when more custom instructions have been selected than can be implemented with the given reconfigurable execution unit resources 730. Step 1430 then proceeds to step 1416 where the user can fix the HDL or select a different set of custom instructions and begin the process of arriving at reconfiguration data again for the selected set of custom instructions again.

In step 1434 the user finishes writing the program, optionally using the selected custom instructions, and optionally modifying existing code to use custom instructions in place of existing code sections. Next, the program is compiled in step 1436, and, if the option is available, the compiler is preferably informed about the custom instructions that are available so that the compiler may make substitutions on its own when it believes a custom instruction may improve performance while retaining the same program behavior. In step 1438 the compilation is examined for success and if successful, the process moves to step 1442. If the compilation was not successful, the errors are reported to the user at step 1440. The process of modifying the program for compilation is then restarted in step 1434.

In step 1442 the compiled object code is added to the program binary and the program binary is loaded in the ready-to-run database. Once the user initiates a program run the process proceeds from 1444 to 1446 where the program binary is fetched from the ready-to-run database. Next, hardware is recruited, reconfiguration data is loaded into reconfiguration memory 740 and reconfiguration is initiated. Once the reconfigurable execution units 730 have been reconfigured the process proceeds to step 1450.

In step 1450 the program binary is loaded into instruction memory 2140, data memory 2100, or into both memories, with execution starting in instruction memory. In an alternative embodiment, instruction cache is used in which case the instructions are loaded into data memory first and then will be cached to instruction cache. Finally, the program is run in step 1452.

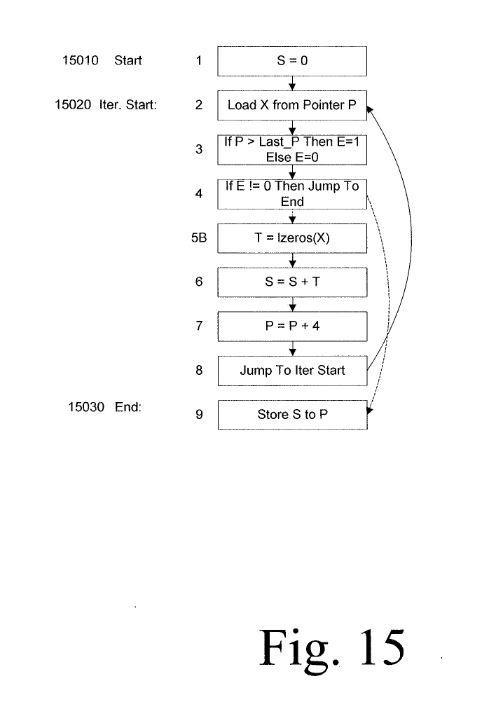

Referring now to FIG. 15, the program of FIG. 12 is shown modified to use the custom instruction “lzeros”. The lzeros instruction counts leading zeroes, as shown in the third row of the custom instruction set of FIG. 13. The program of FIG. 15 is identical to FIG. 12, except for the replacement of steps 5-97 of FIG. 12 with new step 5B of FIG. 15. This custom instruction replaces over 90 default instructions in the program of FIG. 12. The custom instruction delivers up to 90× better performance, and in typical cases the program with the custom instruction will see performance improvements of 2×-10×.

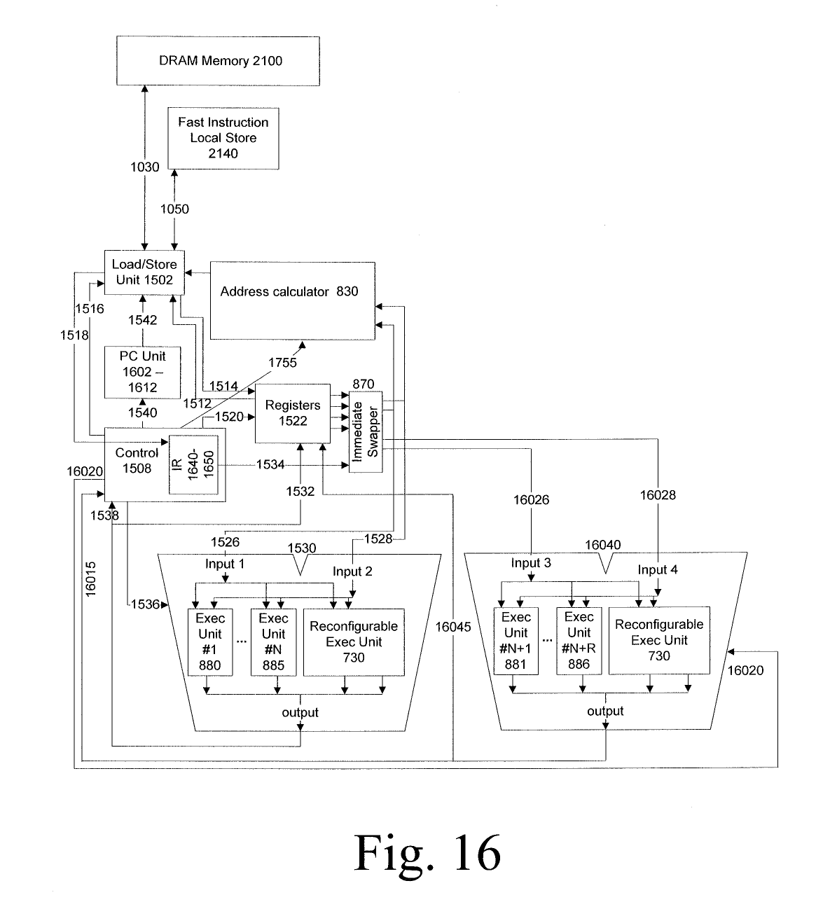

FIG. 16 shows an illustrative embodiment in which instructions are fetched in bundles of two, called long-instruction-words, and wherein the instruction register holds both instructions, one of which has been compiled to run in the first instruction slot (including the ALU hardware 1530), and the other having been compiled to run in a second instruction slot (including ALU hardware 16040). The second instruction slot uses a second ALU 16040, and separate inputs 16026, 16028, and separate output 16015, and separate control link 16020. The instruction in the first instruction slot may be a custom instruction loaded into the reconfigurable execution unit 730. The instruction in the second instruction slot may be a custom instruction loaded into reconfigurable execution unit 730.

FIG. 17 shows the same architecture from FIG. 16 with the exception that the reconfigurable execution units 730 are implemented with a single execution unit 17010. This new configuration allows, for example, reconfigurable resources 700 and 715 that are not needed for instruction slot 1 in ALU 1530 to be used by ALU 16040. In this way it is possible for one instruction slot to implement complex instructions requiring more resources than would be available in the implementation of FIG. 16. Thus in FIG. 17 the division of resources 700 and 715 between the ALUs 1530, 16040 is determined by the HDL compiler after manufacturing rather than predetermined before manufacturing. This allows instructions to be implemented in the single execution unit 17010 that could not have been implemented by separate reconfigurable execution units 730.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An integrated circuit (IC) comprising:
(a) a non-reconfigurable multi-threaded processor core that implements a pipeline having n ordered stages, wherein n is an integer greater than 1, the multi-threaded processor core implementing a default instruction set; and
(b) reconfigurable hardware (e.g., FPGA) that implements n discrete pipeline stages of a reconfigurable execution unit, wherein the n discrete pipeline stages of the reconfigurable execution unit are pipeline stages of the pipeline that is implemented by the multi-threaded processor core.

2. The IC of claim 1 wherein the reconfigurable hardware is configurable for executing one or more instructions.

3. The IC of claim 2 wherein the one or more instructions are not included in the default instruction set.

4. The IC of claim 3 wherein the one or more instructions are user-defined.

5. The IC of claim 1 wherein the processor core is a hard core.

6. An integrated circuit (IC) comprising:
(a) a non-reconfigurable multi-threaded processor core that implements a pipeline having n ordered stages, wherein n is an integer greater than 1, the multi-threaded processor core implementing a default instruction set; and
(b) reconfigurable hardware configurable for executing one or more instructions that are not included in the default instruction set. wherein execution of the non-default instructions utilizes fetch, decode, register dispatch, and register writeback pipeline stages implemented in the same non-reconfigurable pipeline stages used for the performance of instructions in the default instruction set.

7. The IC of claim 6 wherein the multi-threaded processor core further implements an instruction decoder that decodes the default instruction set and the one or more instructions that are not included in the default instruction set.

8. The IC of claim 6 wherein the processor core is a hard core.
